(19) United States
(12) Patent Application Publication
(10) Pub. No.: US 2024/0143816 A1
(43) Pub. Date: May 2, 2024

(54) Information Acquisition, Filtering and Analyzing System and Method

(71) Applicant: CHANALYTICS IO, LLC, Lehi, UT (US)

(72) Inventor: Greg Born, Orem, UT (US)

(73) Assignee: CHANALYTICS IO, LLC, LEHI, UT (US)

(21) Appl. No.: 17/976,231

(22) Filed: Oct. 28, 2022

(51) Int. Cl. G06F 21/62

(52) U.S. Cl. CPC G06F 21/6218

(57) ABSTRACT

Disclosed herein is a method and a system that includes receiving, information from user, sending, a request for authorization to a device associated with one or more collection units. Also receiving, a grant of authorization from a device associated with one or more collection units to access stored information and determining, what information among the stored information is target Information. Extracting, target information from a database associated with the one or more collection units and sending, target information to a device associated with the user. Further, identifying, one or more variables associated with the target information and generating, a graphical analysis using the one or more identified variable of the target information.

### TECHNICAL FIELD

The disclosure relates generally to an information acquisition, filtering and analyzing system and method.

### BACKGROUND

Our world runs on information. Both collecting and passing this information is time consuming and requires substantial financial resources. Anciently smoke signals, birds, flags, runners, and signal fires were used to convey information from one place to another. These methods of passing information were effective when the message was simple and there were only two possible responses. Passing information was enhanced with the production of the alphabet. Written information in messages were then passed by delivering these messages on foot or traveling using animals.

The ability to acquire and control information can be an advantage in virtually any field. For example, certain cattle breeds become popular not just because of their positive physical traits but because of the predictably of these traits. This predictability comes as a result of an abundant amount of collected information regarding these breeds and their traits. Therefore, increasing the information about a particular cattle breed can increase the value of the cattle breed through trait predictability. The passing on of this information can be difficult and time consuming. For example, the collection of the information such as birth weight, sire, and dam must be collected by someone on site and then transferred to a network that consolidates the information collected from various locations.

Being able to predict an outcome more accurately can be extremely advantageous in many ways and across many disciplines. Disciplines such as, engineering, marketing, epidemiology, manufacturing, athletics, public heath, agriculture, research, social services, pharmacology, genetics and many more, can greatly benefit from information that is suggestive of a particular outcome.

The manner of sharing information can be difficult, time consuming and expensive. The complexity of information sharing increases as the number of parties requiring the information increases as each party may require different information. Moreover, the receiving party may desire more information than the collecting party has resources required to send the information. Additionally, the collecting party may have collected information that is confidential and is not to be shared with the receiving party. Accordingly, additional resources may be required by the collecting party to sift out confidential information before it is sent to the receiving party.

The various reasons that the information needs to be shared may include group research project, joint ventures, contractual relationships, manufacturer retailer relationships. Whatever requires individuals or organization to share information, the ease of passing on the appropriate information in a timely manner can be helpful in a variety of circumstances.

### SUMMARY

Disclosed herein is a method and a system that includes receiving, information from user, sending, a request for authorization to a device associated with one or more collection units. The method and system may further include a grant of authorization from a device associated with one or more collection units to access stored information and determining, what information among the stored information is target Information. The method and system may further include extracting, target information from a database associated with the one or more collection units and sending, target information to a device associated with the user. Further, the method and system may include identifying, one or more variables associated with the target information and generating, a graphical analysis using the one or more identified variable of the target information.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a schematic flow chart of an information acquisition, filtering and analyzing system.

FIG. 2 illustrates an example computing system, according to an embodiment of the disclosure.

FIG. 3 illustrates a schematic flow chart diagram of a method for an information acquisition, filtering and analyzing system.

FIG. 4 illustrates a schematic diagram of an information acquisition, filtering and analyzing system.

### DETAILED DESCRIPTION

In the following description, for purposes of explanation and not limitation, specific techniques and embodiments are set forth, such as particular techniques and configurations, in order to provide a thorough understanding of the system disclosed herein. While the techniques and embodiments will primarily be described in context with the accompanying drawings, those skilled in the art will further appreciate that the techniques and embodiments may also be practiced in other similar systems.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

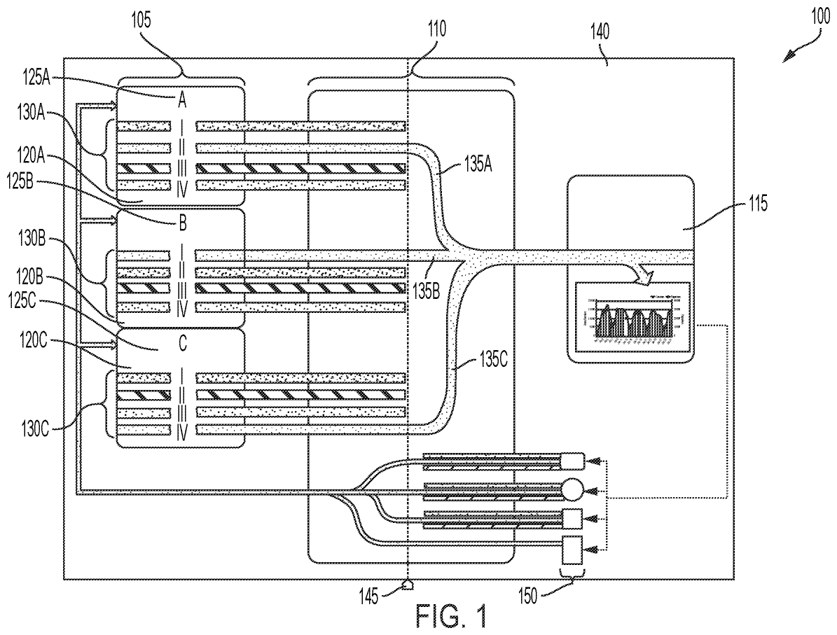

FIG. 1 illustrates a schematic flow chart 140 of an information acquisition, filtering and analyzing system 100. The system 100 may be included in a non-transitory computer readable storage medium containing instructions which when executed by a processor cause the processor to perform a method. The system 100 may include coalition tool 105, filtering tool 110 and analysis tool 115. Coalition tool 105 may include one or more collection units exemplified by collection units 120A-C. Coalition tool 105 may include collection units including more or less than that of collection units 120A-C. Collection units 120A-C may include unit identifiers 125A-C and information sets 130A-C. Again, analytical system 100 may contain more or less than unit identifiers 125A-C and information sets 130A-C. Unit identifiers 125A-C may include a name, alpha numeric number, color or other symbolic unit identifiers 125A-C. For example, if collecting unit 125A is a retail store the identifying unit 125 may be the name of the store, a color representing the store, or other symbols representing the store. Each collecting unit may be controlled by a different entity. Accordingly, one or more of entity may adjust the filtering parameters of filter 145. Alternatively, the filter parameters may be preset before implementation. The information seeker may have the ability to adjust the filter parameters of filter 145. The system 100 may be able to integrate electronically to one or more of collection units 120A-C. Additionally, the integration process may require a secure authentication process.

System 100 may use existing collection units 120A-C set up by the entities that control one or more of collecting units 120A-C. Each collecting unit 120A-C may include a corresponding information set 130A-C respectively. Information sets 130A-C may include information/data concerning one or more subjects I-IV each subject has unique information that pertains to the associated subjects I-IV. Subjects I-IV in collection unit 120A may be different than subjects I-IV found in collection units 1208 and/or 120C. Alternatively, one or more subjects I-IV in collection unit 120A may be the same as subjects I-IV found in collection units 1208 and/or 120C. Selected subjects I-IV may be passed from one or more of collection units 120A-C to the filter tool. Subjects I-IV may be selected manually or may be selected by system 100 that seeks and collects related information to be sent to filtering tool 110. The subjects selected may include one or more of target information sets 135A-C and long non-target information sets. Filtering tool 110 then filters out the non-target information.

Filter 145 may use unique codes identifiers to filter out the non-target information passing on the target information to analysis tool 115. System 100 may also use key identifiers (e.g., key words) determined by the system using the information input by the receiving party. The analysis tool 115 consolidates the filtered information from one or more of collection units 120A-C and provides options to the user on how to view the information. The user can view the information in an aggregated or a disaggregated form.

In the aggregated for the information may be amalgamated by system 100 into a single view. Analysis tool 115 may produce graphical representation of the information to be displayed on an electronic device of a user. Analysis tool 115 may include the ability to perform various statistical analyses to further examine the information. Analysis tool 115 may further be used to trigger the change in secondary variables 150. Secondary variable 150 may include certain behavioral technics or investment protocols that may influence the outcome of the information. Based on the information passed to the analysis tool the analysis tool may implement changes to one or more of secondary variables 150. Further, the analysis tool 115 may display suggested changes to secondary variables 150 to later be made by the user. If one or more of secondary variables 150 are activated, analysis tool 115 may indicated the success or failure of the analysis tool. Analysis tool 115 may further indicate one or more alterations that need to be made to secondary variables 150. These changes may be unique to one or more of collecting units 120. System 100 implements the changes to secondary variables 150 to target the organization represented by one or more of unit identifiers 125A-C. Changes made to secondary variables 150 in turn affect changes that are then reflected in the information collected in one or more of collection units 120A-C.

To illustrate, the information acquisition, filtering, and analyzing system 100 may be used in a relationship between a manufacturer and an online retailer. The manufacturer produces baby blue vegetables to be sold in three online retail stores, for example, A-mart B-mart and C-mart. The online stores may function as coalition tool 105 as they collect information about the products they sell. Individually A-mart, B-mart, and C-mart form collection units 120A-C respectively. The name A-mart may be used as unit identifier 125A. Likewise, B-mart and C-mart may be used as unit identifiers 125B and 125C respectively. Each store includes a collection unit 120A-C that collects information about the different brands of goods they sell that include baby blue vegetables, including clickstream information. This information is gathered into information sets 130A-C.

The information gathered may include: customer identification information, information about where products were located before they came to the online store, information about a total number of products in a basket, information about a type of click event, information about how long the use was on the store site, information about a category of products, information about the products in the basket at the time of purchase, information of the total price of goods, information about any factors that lead them to the store site in the first place, information about how a customer navigates through the online store, information about what products are searched, information about what features were engaged in on the site, information about whether the user was a first time or frequent visitor, information about where the user went next online, etc. The information collected may affect the sale of a product. A-mart, B-mart, and C-mart all may use different methods of selling baby blue vegetables.

The manufacturer may be interested to discover what factors are the most successful in selling the vegetables. Baby blue vegetables manufacturer discovers information acquisition, filtering and analyzing system 100 can help access this information with minimal disruption for A-mart, B-mart, and C-mart. With permission from A-mart, B-mart, and C-mart information acquisition, filtering and analyzing system 100 accesses the information in collection units 120A-C and analyzes the information sets 130A-C. Then filtering tool 110 uses filter 145 to filter off information that is not target information 135 that the manufacturer is seeking. After filter 145 is applied, the target information that remains is consolidated and sent to the manufacturer. System 100 automatically selects product placement as a variable to be analyzed by system 100 because the information accessed by system 100 indicated that A-mart, B-mart, and C-mart each have different product placement strategies for baby blue vegetables.

System 100 analyzes using analysis tool 115 and creates a graph comparing the number of sales per online store compared to the product placement per online store. System 100 may also be able to access the pricing system of how much it will cost to move a product to a more desirable location in the online store and provides an analysis of whether it is worth paying more money preferential placement. Other suggestions may be included such as coupons, promotional videos, and other advertisements. These possible alterations are secondary variables 150. Manufacturer may choose one or more of these alterations which information is input into system 100. After a period of time the manufacturer may be able to track the profitability of changes to the secondary variables 150.

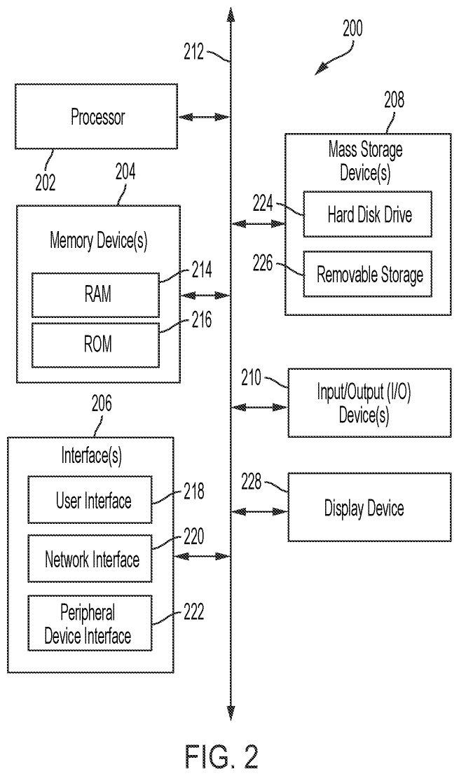

FIG. 2 illustrates a block diagram of an example computing device 200 is illustrated. Computing device 200 may be used to perform various procedures, such as those discussed herein. In one embodiment, the computing device 200 can function as a vehicle controller, a server, and the like. Computing device 200 can perform various monitoring functions as discussed herein, and can execute one or more application programs, such as the application programs or functionality described herein. Computing device 200 may be any of a wide variety of computing devices, such as a desktop computer, in-dash computer, vehicle control system, a notebook computer, a server computer, a handheld computer, tablet computer, smart television, and the like.

Computing device 200 includes one or more processor(s) 202, one or more memory device(s) 204, one or more interface(s) 206, one or more mass storage device(s) 208, one or more Input/output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, wireless or wired remote control devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 may include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, or any suitable user interface now known to those of ordinary skill in the field, or later discovered), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 200 and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

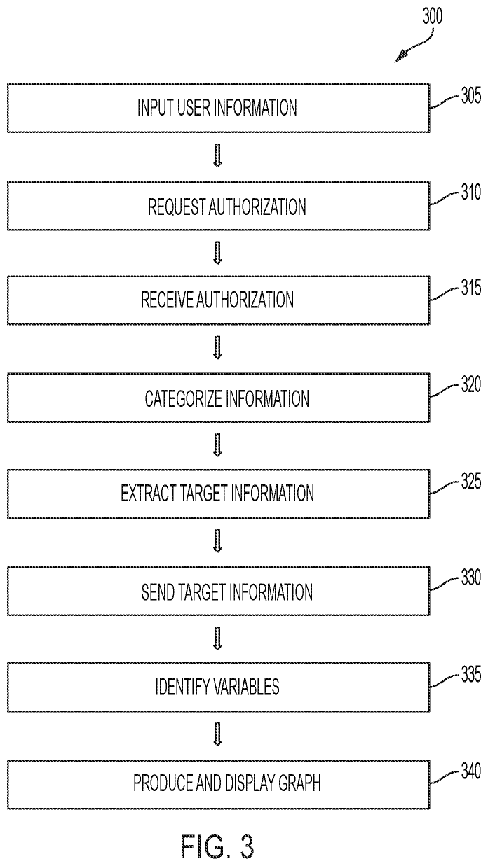

FIG. 3 illustrates a block diagram of a method 300 for an information acquisition, filtering and analyzing system 100 (as seen in FIG. 1). Method 300 is intended to be exemplary such that one or more of the items in the diagram can be rearranged in a different order and still function appropriately. Method 300 may be included in a non-transitory computer readable storage medium containing instructions which when executed by a processor cause the processor to perform a method. Method 300 may include input user information 305 the information one or more unit identifiers 125A-C of collection units 120A-C as depicted in FIG. 1. Furthermore, input 305 may also include a description on one or more target information sets 135A-C as depicted in FIG. 1. More specific information may be included additional information to acquire one or more of target information sets 135A-C such as a stock keeping unit (“SKU”) code, universal product code (“UPC”), or a topic or other identifying features that will help analytical system 100 more efficiently use the coalition tool 105 and the filtering tool 110.

Once the one or more collection units 120A-C have been identified a request for authorization 305 may be sent to an authorized individual of the one or more collecting units 120A-C. System 100 may include a prepopulated email and or a letter to be sent. The system 100 may include a progress tracking tool that provides a visual indication of the progress being made. This may be done by highlighting the completed steps or putting a checkmark or other indication that the step has been completed. Once request authorization 310 has been completed the collection unit may need to provide authorization to access the information, they have collected pertinent to the requester. Request Authorization 310 may include information about the benefits of authorizing access to the information. This information can include the robust security system, the limit of the information shared to the requester, and or the number of resources saved. Request authorization 310 may also include an option to share what information is being shared to the requester. The information may be required to be shared with the requester and will likely be beneficial to the collection units 120A-C. Request authorization may be sent using secure tokens to ensure security.

Once one or more of collection units 120A-C authorizes access to their information the authorization is sent and received by system 100. Received authorization 315 may allow the system to access the information of the collection units 120A-C. After gaining access to the information associated with one or more of the collection units 120A-C system 100 may begin to categorize the information found in the one or more collection units 120A-C. System 100 may further use information provided during input user information 305. Once categorize information step is complete system 100 may begin extract target information 325. This process of extraction may happen using the filter tool 110 and more specifically the filter 145 which is used to prevent non-target information from passing to the requester.

Target information may be associated with target information sets 135A-C. During extract target information step 325, certain pieces of information that may or may not be part of the target information may be flagged for further review. The system may determine who to review the information whether it be person associated with one or more of the collecting units 120A-C. System 100 may send the completed information to one or more of the requesters and to collection units 120A-C. When information is sent or received in any of these steps it may be sent and or received by an electronic device discussed in FIG. 3. The next step may be to send target information 325, which may be associated with target information sets 135A-C, one or more of the requesters or a person associated with collection units 120A-C.

Once system 100 has filtered using filter 145 off non-target information it may use the target information to proceed to identify variables 335 step to be analyzed within the information provided. A variable may be a piece of information that is suspected to further define sent target information 135A-C. In identify variables 335 step one or more variables may be selected either by system 100 or by the requester to proceed to produce and display a graph 340 step. System 100 uses the one or more variables and produces a graph displaying the results. This graph can be sent and displayed on one or more devices associated with the requestor and a device associated with collection units 120A-C.

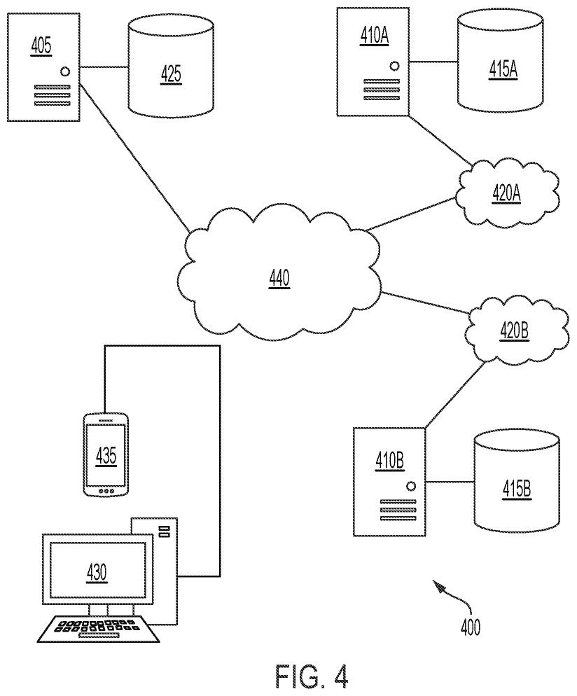

FIG. 4 illustrates a schematic diagram of an information acquisition, filtering and analyzing system 400. System 400 may include a requestor platform 405 where a requester may use computer 430 or a mobile device 435 to begin the process of using system 400. Communication may occur between requestor platform 405 to one or more collection units 130A-B, as presented in FIG. 1. More collection units may be included but for purposes of illustration only collection units 130A-B will be used. Collection units 130A-B may use platforms 410A-B respectively to facilitate the interaction between requestor platform 405 and collection unit platforms 410A-B. Collection units 130A-B may use respectively databases 415A-B and networks 420A-B. The requester may complete input information step 310, as presented in FIG. 3, through computer 430 or mobile device 435. Moreover, the request authorization step 315, as presented in FIG. 3, may also be requested from requester's platform 405. This request may be received by an electronic device associate with collection units 120A-B, as presented in FIG. 1, on platforms 410A-B. Further, platforms 410A-B may be used to authorize access to the information stored in databases 415A-B. Alternatively, this information may be accessed through networks 420A-B.

The acknowledgment of the completion of receive authorization 315 step may be displayed on platform 405. Platform 405 may display the progress of the steps found in FIG. 3. Once receive authorization 315 step has been completed network 440 has access to information from collection units 130A-B. Once network 440 receives this information system 400 categorizes information 320 step, as presented in FIG. 3, by using the filtering tool 110 more specifically filter 145, as presented in FIG. 1. Once the non-target information is filtered extract target information 330 step, as presented in FIG. 3, can take place. Target information can be displayed on requestors platform 405. The system 400 also identifies variables 335 step, as presented in FIG. 3, where the system 400 identifies one or more variables. The one or more variables can be displayed on requesters platform 405. System 400 may then produce and display graph 340 step, as presented in FIG. 3, where either by request or automatically a graph is displayed on the receiver platform 410.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A non-transitory computer readable storage medium containing instructions which when executed by a processor cause the processor to perform a method, a method comprising:
receiving, information from a user;
sending, a request for authorization to a device associated with one or more collection units;
receiving, a grant of authorization from a device associated with one or more collection units accessing stored information;
determining, what information among the stored information is target information;
extracting, target information from a database associated with the one or more collection units;
sending, target information to a device associated with the user;
identifying, one or more variables associated with the target information; and
generating, a graphical analysis using the one or more identified variable of the target information.

2. The non-transitory computer readable storage medium of claim 1, the method further comprising:
generating, a graph of the graphical analysis.

3. The non-transitory computer readable storage medium of claim 2, the method further comprising:
sending, the graph to the user.

4. The non-transitory computer readable storage medium of claim 1, the method wherein the information received by the user includes information to acquire the target information.

5. The non-transitory computer readable storage medium of claim 1, the method wherein the information to acquire the target information includes stock keeping units.

6. The non-transitory computer readable storage medium of claim 1, the method wherein the one or more collection units are identified in the user information.

7. The non-transitory computer readable storage medium of claim 1, the method wherein sending the request for authorization is generated automatically.

8. The non-transitory computer readable storage medium of claim 1, the method further comprising:
sending, a notification of the extracted target information to a device associated with the collection units.

9. The non-transitory computer readable storage medium of claim 1, the method further comprising:
receiving one or more suggestions to change the secondary variables.

10. The non-transitory computer readable storage medium of claim 9, the method further comprising:
receiving, information concerning the effect after the change of the secondary variables.

11. A system comprising:
a processor to:
receive information from a user;
send a request for authorization to a device associated with one or more collection units;
receive a grant of authorization from a device associated with one or more collection units accessing stored information;
determine, what information among the stored information is target information;
extract, target information from a database associated with the one or more collection units;
send, target information to a device associated with the user;
identify, one or more variables associated with the target information; and
generate, a graphical analysis using the one or more identified variable of the target information.

12. The system of claim 11, further comprising:
generating, a graph of the graphical analysis.

13. The system of claim 11, further comprising:
Sending, the graph to the user.

14. The system of claim 11 wherein the information received by the user includes information to acquire the target information.

15. The system of claim 11 wherein the information to acquire the target information includes stock keeping units.

16. The system of claim 11 wherein the one or more collection units are identified in the user information.

17. The system of claim 11 wherein sending the request for authorization is generated automatically.

18. The system of claim 11, further comprising:
sending, a notification of the extracted target information to a device associated with the collection units.

19. The system of claim 11, further comprising:
receiving one or more suggestions to change the secondary variables.

20. The system of claim 11, further comprising: receiving, information concerning the effect after the change of the secondary variables.
